(19) United States
(12) Patent Application Publication
(10) Pub. No.: US 2020/0256529 A1
(43) Pub. Date: Aug. 13, 2020

(54) Lighting Device

(71) Applicant: Roger McCoy, Kirkville, KY (US)

(72) Inventor: Roger McCoy, Kirkville, KY (US)

(21) Appl. No.: 16/781,131

(22) Filed: Feb. 4, 2020

Related U.S. Application Data
(60) Provisional application No. 62/803,392, filed on Feb. 8, 2019.

(51) Int. Cl. F21S 4/28; F21V 21/096; A45C 15/06; F21Y 115/10

(52) U.S. Cl. CPC F21S 4/28; F21Y 2115/10; A45C 15/06; F21V 21/0965

(57) ABSTRACT

A lighting device for use within a purse or similar container. The lighting device comprises a light strip attachable to the inside of the purse. A magnetic switch component operatively connects a plurality of light emitting diode lights to a power source when the purse is opened. A lighting system comprises a first and a second lighting strip configured as mirror images of each other. Each lighting strip has a magnet and a magnetic switch that operatively connects a plurality of light emitting diode lights to a power source when the purse is opened. The magnet of the first lighting strip is configured to engage the magnetic switch of the second lighting strip and vice versa. A purse with an internal lighting system comprises a purse and a light strip attachable to the inside of the purse.

### CROSS-REFERENCE

This application claims priority from Provisional Patent Application Ser. No. 62/803,392 filed on Feb. 8, 2019.

### BACKGROUND

It can be both difficult and time consuming for people to dig through their purses, bags or other containers to locate an item stored within. This is especially true at night, when the individual is rushed, or in a hurry. People often set the purse or bag down to dig through it, but this is not always practical, convenient, or even possible. Others may attempt to shine an external light source into the purse or bag, but this requires one hand to hold the light and/or purse or bag, thereby leaving only one hand to search the interior of the bag. Additionally, the user must first locate an external light source, which may be inside the bag itself, thereby further complicating the issue. Oftentimes, in frustration, the user ends up just feeling around in the dark for the item until it is located by touch.

These problems are also true for a wide variety of similar bags, such as clutches, totes, shoulder bags, makeup bags, soft luggage, backpacks, paramedic/EMT bags, contractor bags, or any similar flexible carrying container. Generally, these types of bags all have similarities like an opening that is closable with a zipper, button, clasp, or similar closure mechanism. The opening allows the user access to an interior of the bag. However, these bags come in a wide variety of shapes and sizes. Existing lighting systems are not adjustable, and therefore not easily usable on more than one size of shape of bag.

Accordingly, there is a long felt need in the art for a lighting device that makes it relatively easy to locate keys, money, and other personal items enclosed within a bag, purse or other container, thereby effectively eliminating the need to shine a flashlight or smartphone light into the bag and dig around with the other hand. There is also a long felt need in the art for a lighting device that is adjustable in size to accommodate the size of the purse or bag in which it is being used, and that is relatively inexpensive to manufacture and easy to use.

More specifically, the present invention discloses an adjustable lighting device that can potentially save a user a considerable amount of time and frustration searching for items in a pursue, bag or other container, especially in dimly lit environments or at night. Additionally, the lighting device of the present invention alleviates the need and hassle of dumping out all of the contents of the bag or purse in order to locate a single item. The lighting device effectively improves the overall function and convenience of a purse or bag and is adjustable to fit a wide variety of different bag types, sizes, and configurations.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a lighting device for use within a container. The lighting device comprises a housing, a power source, a magnetic switch component, and a lighting component. The magnetic switch component is in electrical communication with the power source, and the lighting component is in electrical communication with the magnetic switch component. The lighting device is attachable to an interior of the container so that the lighting device automatically activates to illuminate the interior of the container once the container is opened by the user.

Additionally, the magnetic switch component comprises both a magnetic switch and a magnet, and the lighting component comprises a plurality of light emitting diode (LED) lights. When the lighting device is installed within the container, the magnetic switch is located so as to come into contact with the magnet once the container is closed. When the container is in the closed position and the magnetic switch is in contact with the magnet, the lighting component is in the off position and is not illuminated, thereby conserving power and the overall life of the LEDs. When the magnetic switch is no longer in contact with the magnet, such as when the container is opened, the lighting component automatically illuminates the interior of the container, such as a purse or a bag.

An additional embodiment of the present invention comprises a lighting system for use within a container. The lighting system preferably comprises a first lighting strip and a second lighting strip. The first lighting strip comprises a first power source, a first magnetic switch component, and a first lighting component. More specifically, the first magnetic switch component is in electrical communication with the first power source, and the first lighting component is in electrical communication with the first magnetic switch component. Similarly, the second lighting strip comprises a second power source, a second magnetic switch component, and a second lighting component. The second magnetic switch component is in electrical communication with the second power source, and the second lighting component is in electrical communication with the second magnetic switch component.

Additionally, the first and second lighting strips are attachable to opposing sides of an interior of the container, such as a purse or a bag, so that the first and second lighting strips automatically activate to illuminate the interior of the container once the container is opened. More specifically, the first and second magnetic switch components each comprise a magnetic switch and a magnet. When the first and second lighting strips are attached to the inside of the container, the magnetic switch of the first magnetic switch component is located opposite the magnet of the second magnetic switch component, and the magnetic switch of the second magnetic switch component is located opposite the magnet of the first magnetic switch component. Consequently, when each of the magnetic switches are in contact with the opposing magnets, the lighting components are not illuminated and power is conserved. When the magnetic switches are no longer in contact with the opposing magnets, such as when the container is opened, the lighting components illuminate thereby lighting up the interior of the container.

An additional embodiment of the present invention comprises a purse with an internal lighting system. The purse with the internal lighting system comprises a purse and a lighting device. The lighting device comprises a housing, a power source, a magnetic switch component, and a lighting component. The magnetic switch component is in electrical communication with the power source, and the lighting component is in electrical communication with the magnetic switch component. The lighting device is attachable to an interior of the purse so that the lighting device activates to illuminate the interior of the purse once the purse is opened.

The magnetic switch component comprises a magnetic switch and a magnet. The lighting component comprises a plurality of light emitting diode lights. When the lighting device is installed within the purse, the magnetic switch is located so as to come into contact with the magnet once the purse is closed. When the magnetic switch is in contact with the magnet, the lighting component is not illuminated. When the magnetic switch is no longer in contact with the magnet, such as when the purse is opened, the lighting component illuminates an interior of the purse.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1A illustrates an overhead view of a front side of a lighting device for use within a container in accordance with the disclosed architecture.

FIG. 1B illustrates an overhead view of a back side of the lighting device for use within the container in accordance with the disclosed architecture.

FIG. 2 illustrates a side cut away view of the lighting device installed within the container in accordance with the disclosed architecture.

FIG. 3 illustrates a perspective view of a lighting system for use within a container in accordance with the disclosed architecture.

FIG. 4A illustrates an overhead view of a front side of a first lighting strip of the lighting system for use within the container in accordance with the disclosed architecture.

FIG. 4B illustrates an overhead view of a front side of a second lighting strip of the lighting system for use within the container in accordance with the disclosed architecture.

FIG. 5 illustrates an overhead perspective view of the first and second lighting strips of the lighting system installed within the container in accordance with the disclosed architecture.

FIG. 6 illustrates a side perspective view of the first lighting strip of the lighting system installed within the container in accordance with the disclosed architecture.

FIG. 7 illustrates an overhead perspective view of a purse with an internal lighting system in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a unique device that can be used to illuminate the interior of a purse or bag to quickly locate personal items contained therein. The device features a battery-powered interior lighting system for purses, bags, clutches, totes, handbags, backpacks, duffle bags, makeup bags, and the like. The lighting system of the device may include a magnetic band with a series of spaced LED lights and magnets on either side of the band. The band may then be applied around the opening of a purse or bag, directly below the zipper, button, clasp, or other fastener. Additionally, the band may be applied to many different styles of purses or bags to accommodate user's needs. When the purse or bag is closed, the magnetic band can secure itself together. When the purse or bag is opened and the magnets separate, the lights automatically engage.

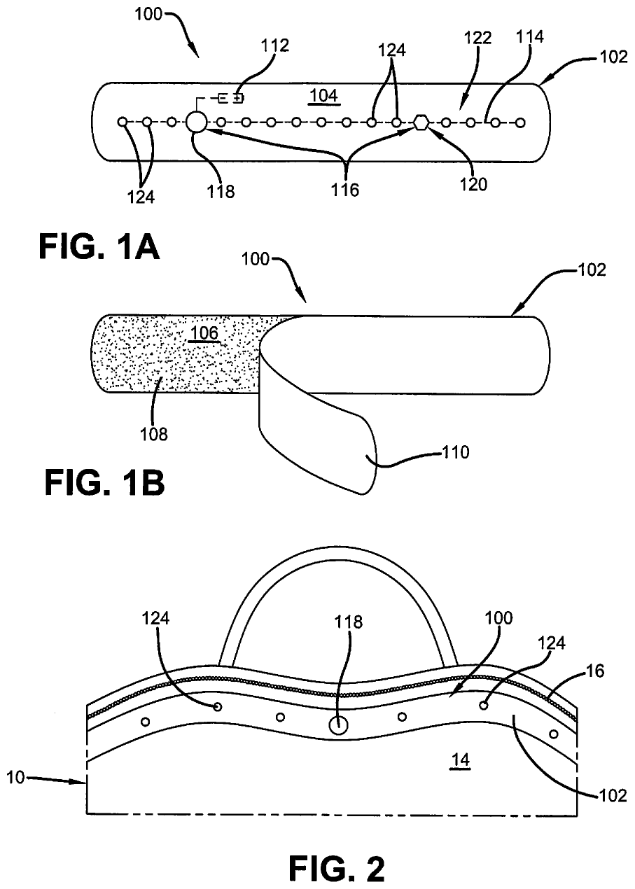

Referring initially to FIGS. 1A through 2, a lighting device 100 for use within a container 10 comprises a housing 102. The container 10 comprises an opening 12, an interior surface 14, and a fastener 16. The container 10 may be a purse, a clutch, a handbag, or the like as described supra. The fastener 16 is a typical closing mechanism such as a zipper, a clasp mechanism, buttons, snaps, or the like. The lighting device 100 is attachable or securable to the interior surface 14 of the container 10, typically around the opening 12 just below the fastener 16 and around a perimeter of the opening 12.

The housing 102 is typically configured as a strip and comprises a front side 104 and a back side 106. The back side 106 comprises an attachment element 108. The attachment element 108 is configured to attach to the interior surface 14 of the container 10. As illustrated in FIG. 1B, the attachment element 108 may be an adhesive layer, a mechanical fastening system, a hook and loop fastening system or the like. The back side 106 may further comprise a backing layer 110 to protect the attachment element 108 prior to installation of the lighting device 100 to the interior surface 14 of the container 10.

The lighting device 100 further comprises a power source 112 located or embedded within the housing 102. The power source 112 is typically a battery. The lighting device 100 further comprises a magnetic switch component 116 and a lighting component 122. The magnetic switch component 116 is attached to the front side 104 of the housing 102 and is in electrical communication with the power source 112 via wiring 114 embedded within or located on the housing 102. The magnetic switch component 116 comprises at least one magnetic switch 118 and at least one magnet 120. The magnetic switch 118 may be a Reed switch, a Hall Effect sensor, or any other type of magnetically operable switch known to one of skill in the art.

The lighting component 122 is in electrical communication with the magnet switch component 116 via wiring 114 embedded within or located on the housing 102. The lighting component 122 typically comprises a plurality of light emitting diode (LED) lights 124. The lighting component 122 may be positioned on the front side 104 of the housing 102 or embedded within the front side 104 of the housing 102 so that each of the plurality of LED lights 124 are oriented to illuminate the interior of the container 10 when opened.

Once in position within the container 10, the magnetic switch 118 will be oriented approximately across from the magnet 120 on the opposing inside surface of the container 10. When the container 10 is closed, the magnetic switch 118 magnetically engages the magnet 120 so that an open circuit is created and the lighting component 122 is not activated, conserving battery life. When the container 10 is opened, the magnetic switch 118 is mechanically separated from the magnet 120 completing the circuit and activating and illuminating the lighting component 122, thereby illuminating an interior of the container 10. Separating the magnetic switch 118 from the magnet 120 causes the magnetic switch 118 to “toggle” completing the circuit between the lighting component 122 and the power source 112 activating the plurality of LED lights 124.

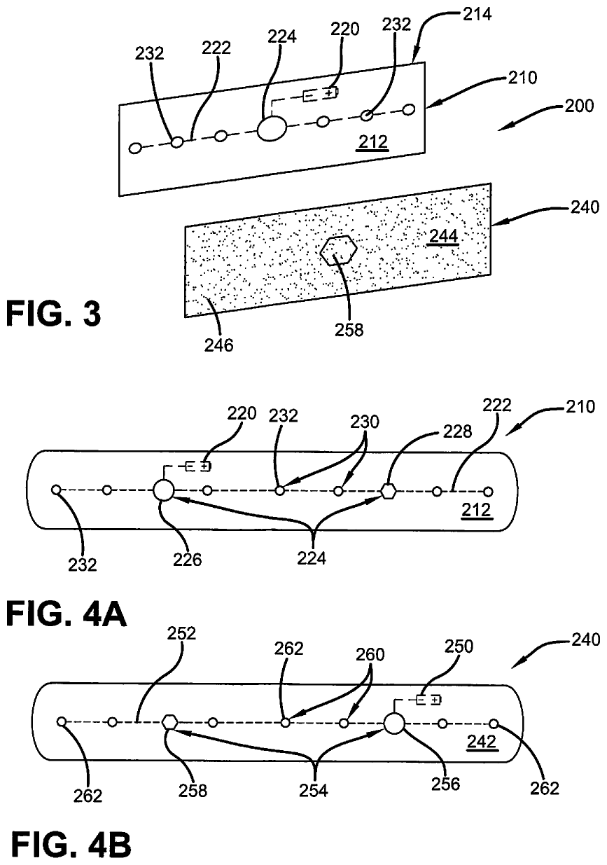

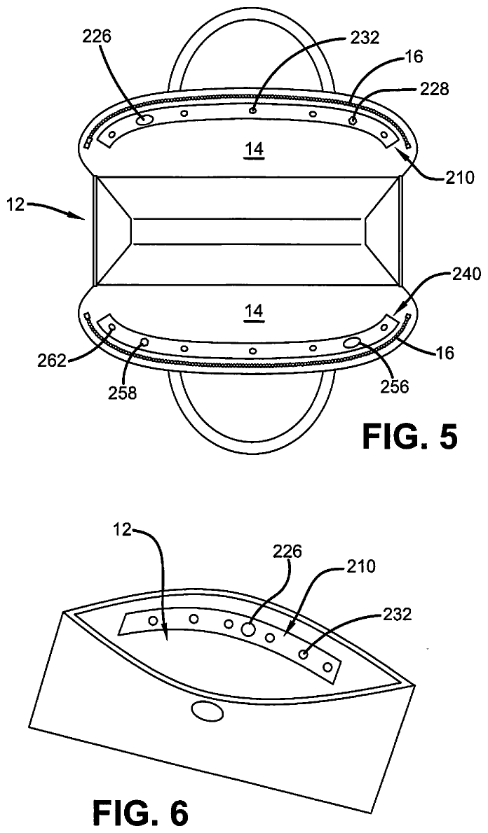

As illustrated in FIGS. 3-6, a lighting system 200 for use within a container 10 comprises a first lighting strip 210 and a second lighting strip 240. As before, the container 10 comprises an opening 12, an interior surface 14, and a fastener 16. The container 10 may be a purse, a clutch, a handbag, or the like as described supra. The fastener 16 is a typical closing mechanism such as a zipper, a clasp mechanism, buttons, snaps, or the like. The lighting system 200 is attachable or securable to the interior surface 14 of the container 10, typically around the opening 12 just below the fastener 16 and around a perimeter of the opening 12.

The first lighting strip 210 and the second lighting strip 240 each comprise a front side 212 and 242 and a back side 214 and 244 respectably. The back sides 214 and 244 each comprise an attachment element 246. The attachment elements 246 are configured to attach to the interior surface 14 of the container 10. As in the previous embodiment, the attachment elements 246 may be an adhesive layer, a mechanical fastening system, a hook and loop fastening system or the like. The back sides 214 and 244 may further comprise a backing layer (similar to 110) to protect the attachment element prior to installation of the first and second lighting strips 210 and 240 to the interior surface 14 of the container 10.

As illustrated in FIG. 4A, the first lighting strip 210 further comprises a first power source 220 located or embedded within the first lighting strip 210. The first power source 220 is typically a battery. The first lighting strip 210 further comprises a first magnetic switch component 224 and a first lighting component 230. The first magnetic switch component 224 is attached to the front side 212 of the first lighting strip 210 and is in electrical communication with the power source 220 via wiring 222 embedded within or located on the first lighting strip 210. The first magnetic switch component 224 comprises at least one magnetic switch 226 and at least one magnet 228.

The first lighting component 230 is in electrical communication with the first magnet switch component 224 via wiring 222 embedded within or located on the first lighting strip 210. The first lighting component 230 typically comprises a plurality of LED lights 232. The first lighting component 230 may be positioned on or embedded within the front side 212 of first lighting strip 210 so that each of the plurality of LED lights 232 are oriented to illuminate the interior of the container 10 when opened.

As illustrated in FIG. 4B, the second lighting strip 240 further comprises a second power source 250 located or embedded within the second lighting strip 240. The second power source 250 is typically a battery. The second lighting strip 240 further comprises a second magnetic switch component 254 and a second lighting component 260. The second magnetic switch component 254 is attached to the front side 242 of the second lighting strip 240 and is in electrical communication with the second power source 250 via wiring 252 embedded within or located on the second lighting strip 240. The second magnetic switch component 254 comprises at least one magnetic switch 256 and at least one magnet 258.

The second lighting component 260 is in electrical communication with the second magnet switch component 254 via wiring 252 embedded within or located on the second lighting strip 240. The second lighting component 260 typically comprises a plurality of LED lights 262. The second lighting component 260 may be positioned on or embedded within the front side 242 of second lighting strip 230 so that each of the plurality of LED lights 262 are oriented to illuminate the interior of the container 10 when opened.

As illustrated in FIG. 3, once in position within the container 10, the magnetic switch 226 of the first magnetic switch component 224 is aligned within the container 10 to be approximately across from the magnet 258 of the second magnetic switch component 254 when the container 10 is closed. Similarly, the magnetic switch 256 of the second magnetic switch component 254 is aligned within the container 10 to be approximately across from the magnet 228 of the first magnetic switch component 224 when the container 10 is closed.

When the container 10 is closed, the magnetic switches 226 and 256 magnetically engage the opposing magnets 258 and 228 so that an open circuit is created and the first and second lighting components 230 and 260 are not activated, conserving battery life. When the container 10 is opened, the magnetic switches 226 and 256 are mechanically separated from the opposing magnets 258 and 228 completing the circuits and activating and illuminating first and second lighting components 230 and 260, thereby illuminating an interior of the container 10. Separating the magnetic switches 226 and 256 from the opposing magnets 258 and 228 causes the magnetic switches 226 and 256 to complete the circuits between the first and second lighting components 230 and 260 and the first and second power sources 220 and 250 activating the plurality of LED lights 232 and 262.

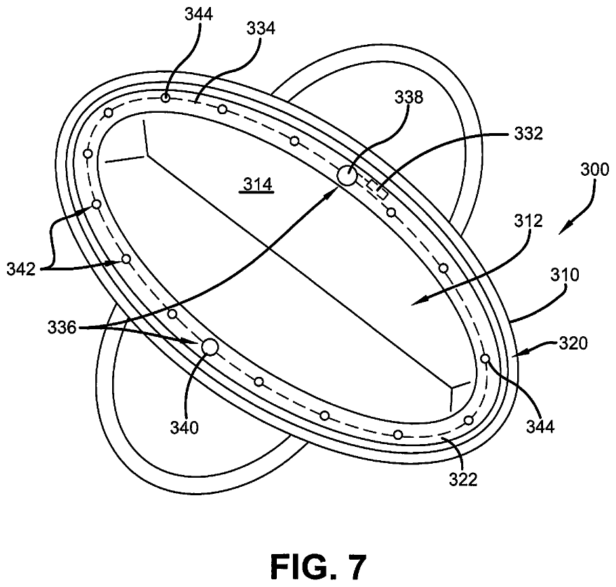

As illustrated in FIG. 7, a purse with an internal lighting system 300 comprises a purse 310 and a lighting device 320. The purse 310 comprises an opening 312 and an interior surface 314 The purse may further comprise a fastener (not shown) similar to the fasteners discussed supra. The lighting device 320 is attachable or securable to the interior surface 314 of the purse 310 adjacent to the opening 312, typically around a perimeter of the opening 312.

The lighting device 320 comprises a housing 322 comprising a front side (similar to 104) and a back side (similar to 106). The back side comprises an attachment element (similar to 108). The attachment element is configured to attach to the interior surface 314 of the purse 310. The back side may further comprise a backing layer (similar to 110) to protect the attachment element prior to installation of the lighting device 320 to the interior surface 314 of the purse 310.

The lighting device 320 further comprises a power source 332 located or embedded within the housing 322. The power source 332 is typically a battery. The lighting device 320 further comprises a magnetic switch component 336 and a lighting component 342. The magnetic switch component 336 is attached to the front side of the housing 322 and is in electrical communication with the power source 332 via wiring 334 embedded within or located on the housing 322. The magnetic switch component 336 comprises at least one magnetic switch 338 and at least one magnet 340.

The lighting component 342 is in electrical communication with the magnet switch component 336 via wiring 334 embedded within or located on the housing 322. The lighting component 342 typically comprises a plurality of LED lights 344. The lighting component 342 may be positioned on the front side of the housing 322 or embedded within the front side of the housing 322 so that each of the plurality of LED lights 344 are oriented to illuminate the interior of the purse 310 when opened.

Once in position within the purse 310, the magnetic switch 338 will be oriented approximately across from the magnet 340 on the opposing inside surface of the purse 310. When the purse 310 is closed, the magnetic switch 338 magnetically engages the magnet 340 so that an open circuit is created and the lighting component 342 is not activated, conserving battery life. When the purse 310 is opened, the magnetic switch 338 is mechanically separated from the magnet 340 completing the circuit and activating and illuminating the lighting component 342, thereby illuminating an interior of the purse 310. Separating the magnetic switch 338 from the magnet 340 causes the magnetic switch 338 to complete the circuit between the lighting component 342 and the power source 332 activating the plurality of LED lights 344.

It is also contemplated that the various embodiments of the lighting device of the present invention described herein may further comprise a manual on/off switch such that the lights may be, for example, powered on when the container is closed or powered off when the container is open, or at any other time to suit user need and/or preference. For example, a user, such as an EMT or contractor, may need to leave their bag open throughout the day while working, and when the light is not necessarily needed. In this manner, having a manual on/off switch (or other power interrupter) would be useful for conserving battery power and the overall useful life of the lighting device.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A lighting device for use within a container comprising:
a housing comprising a front side and a back side;
a power source located within the housing;
a magnetic switch component in electrical communication with the power source; and
a lighting component in electrical communication with the magnetic switch component.

2. The lighting device of claim 1, wherein the lighting device is attachable to an interior surface of the container.

3. The lighting device of claim 1, wherein the back side of the housing comprises an attachment element.

4. The lighting device of claim 3, wherein the attachment element is an adhesive.

5. The lighting device of claim 1, wherein the magnetic switch component comprises a magnetic switch and a magnet.

6. The lighting device of claim 5, wherein separating the magnet from the magnetic switch activates the lighting component.

7. The lighting device of claim 5, wherein positioning the magnet adjacent to the magnetic switch deactivates the lighting component.

8. The lighting device of claim 1, wherein the lighting component illuminates when the container is opened.

9. The lighting device of claim 1, wherein the lighting component comprises a plurality of light emitting diode lights.

10. The lighting device of claim 1, wherein the lighting component is positioned on the front side of the housing.

11. The lighting device of claim 1, wherein the lighting component is embedded within the front side of the housing.

12. The lighting device of claim 1, wherein the container is a purse.

13. The lighting device of claim 1, wherein the power source is a battery.

14. A lighting system for use within a container comprising:
a first lighting strip comprising:
a first power source; a first magnetic switch component in electrical communication with the first power source; and a first lighting component in electrical communication with the magnetic switch component; and
a second lighting strip comprising:
a second power source; a second magnetic switch component in electrical communication with the first power source; and a second lighting component in electrical communication with the magnetic switch component.

15. The lighting device of claim 14, wherein the first and second magnetic switch components each comprise a magnetic switch and a magnet.

16. The lighting device of claim 15, wherein the magnetic switch of the first magnetic switch component is aligned within the container to be in contact with the magnet of the second magnetic switch component when the container is closed.

17. The lighting device of claim 14, wherein the first and second lighting components each comprise a plurality of light emitting diode lights.

18. A purse with an internal lighting system comprising:
a purse comprising an opening;
a lighting device attachable to an interior surface of the purse adjacent to the opening, the lighting device comprising: a housing, a power source located within the housing, a magnetic switch component in electrical communication with the power source; and
a lighting component in electrical communication with the magnetic switch component.

19. The purse of claim 18, wherein the magnetic switch component comprises a magnetic switch and a magnet to control activation and deactivation of the lighting component.

20. The purse of claim 19, wherein the lighting component comprises a plurality of light emitting diode lights that illuminate when the container is opened.
